(19) United States
(12) Patent Application Publication
(10) Pub. No.: US 2020/0139491 A1
(43) Pub. Date: May 7, 2020

(54) Position Shifting Base

(71) Applicant: Jason Alen Marburger, Spokane, WA (US)

(72) Inventor: Jason Alen Marburger, Spokane, WA (US)

(21) Appl. No.: 16/180,886

(22) Filed: Nov. 5, 2018

(51) Int. Cl. B23K 37/04

(52) U.S. Cl. CPC B23K 37/0461

(57) ABSTRACT

Present invention consists of a block with a cylindrical stud and a cylindrical hole. A hex-head screw comprises a screw head portion, a middle portion and a threaded portion. The threaded portion of the hex-head screw can be fitted to the base of a clamp through the cylindrical hole, so that the clamp can freely rotate, using the cylindrical stud as a pivoting point, and the clamp's location on a welding table can be shifted to provide a proper location on the surface of a work piece.

### FIELD AND BACKGROUND OF THE INVENTION

Present invention relates to an accessory item used together with a typical welding table. On such a welding table, clamps can be inserted to the holes on the table top to clamp on work pieces. Generally, the holes on a typical welding table are two inches apart from the one next to it.

However, given the fixed formation of the matrix-like holes on a welding table, work piece will differ in sizes and shapes, and under different circumstances, sometimes it becomes difficult for the clamp jaw of the clamp to land on the proper location of the work piece(s) to clamp firmly. The present invention can be added between the clamp and the hole to shift, or offset, the position of the clamp and provide a proper and firm clamping.

### SUMMARY OF THE INVENTION

The invention uses a substantially rectangular block with a cylindrical stud and a cylindrical hole.

The cylindrical hole is made in the same axial direction as said cylindrical stud and through the body of said block.

A hex-head screw can be inserted through the cylindrical hole to attach the present invention to the bottom of a clamp.

The hex-head screw has an indent hex shape to receive a hex driver. The hex-head screw comprises a screw head portion, a middle portion and a threaded portion. The threaded portion of the hex-head screw can be fitted to the base of a clamp (which will have thread lines matching the thread lines of the threaded portion of the hex-head screw) through the cylindrical hole, so that the clamp can freely rotate, using the cylindrical stud as a pivoting point, and the clamp's location on a welding table can be shifted to provide a proper location on the surface of a work piece.

In the description given in this application, the up, down, upper, lower, or bottom terms are given in a common perspective where the gravity direction will be down and the opposite direction will be up.

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

A brief description of the drawings is as follows:

FIG. 1 is the perspective view of the present invention showing the block and the hex-head screw separated from the body of the block.

FIG. 2 shows the broken down view of the present invention in relation to a clamp.

FIG. 3 shows a typical welding table, having a clamp screwed on top of the present invention clamping to a small work piece next to a larger work piece.

### DETAILED DESCRIPTION OF THE PREFERRED EMBODIMENT

The position shifting base of present invention comprises of a substantially rectangular block 100, a cylindrical stud 20 extending from a bottom side of said block 100, and a cylindrical hole 80.

The diameter of the cylindrical stud 20 is made to match the diameter of the holes on a typical welding table top. When the cylindrical stud 20 is inserted into a hole on a welding table, the block 100 is free to rotate on the welding table.

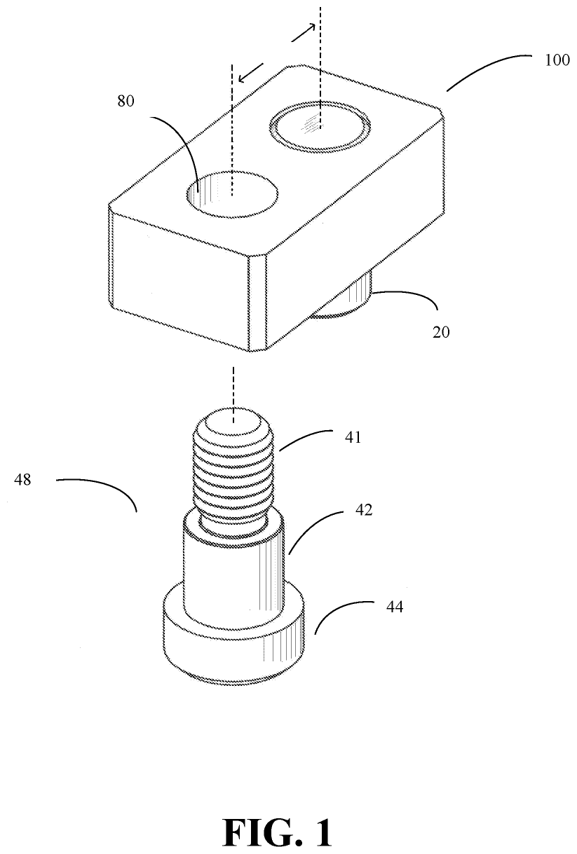

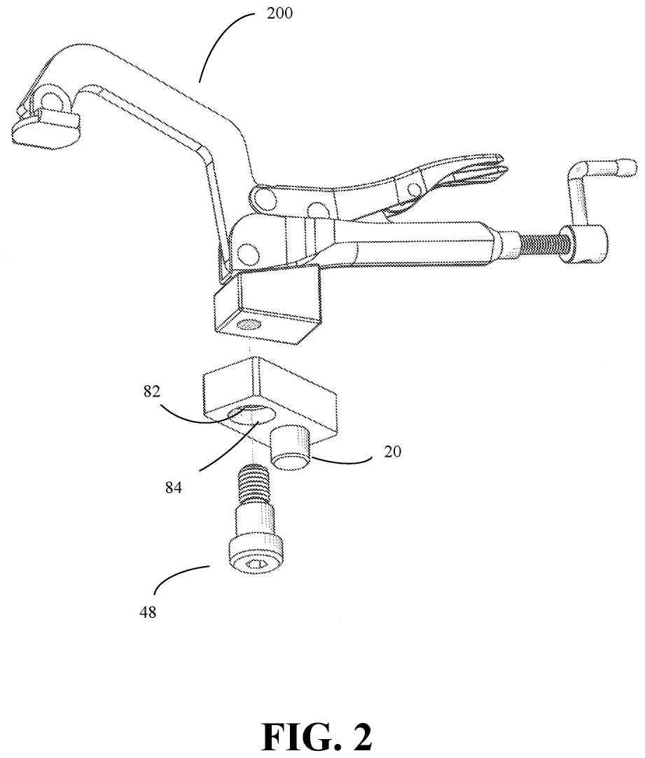

The cylindrical hole 80 is made in the same axial direction as said cylindrical stud 20 and through the body of said block 100, as depicted in FIGS. 1 and 2.

Said cylindrical hole 80 is divided into an upper portion 82 and a lower portion 84.

A hex-head screw 48 is sized to fit through said cylindrical hole 80 wherein said hex-head screw 48 comprises a screw head portion 44, a middle portion 42 and a threaded portion 41.

A clamp 200 can be mounted to the block 100 by the threaded portion 41 of the hex-head screw 48. The length of the hex-head screw 48 is longer than the thickness of the body of the block 100, as shown in FIG. 2, and the threaded portion 41 will protrude out from the block 100 and for threadingly attaching to a clamp 200. The length of the screw head portion 44 can be made to be slightly shorter than the length of the lower portion 84 of the cylindrical hole 80, and the length of the middle portion 42 can be made to be slightly longer than the upper portion 82 of the cylindrical hole 80.

The diameter of the screw head portion 44 is larger than that of the middle portion 42; the diameter of the middle portion 42 is larger than that of the threaded portion 41. The diameter of the cylindrical hole 80's upper portion 82 is sized to fit the middle portion 42 of the hex-head screw 48. The diameter of the cylindrical hole 80's lower portion 84 is sized to fit the screw head portion 44 of the hex-head screw 48.

The center line of the cylindrical stud 20 and the centerline of the cylindrical hole 80, as shown in FIG. 1, are one inch apart.

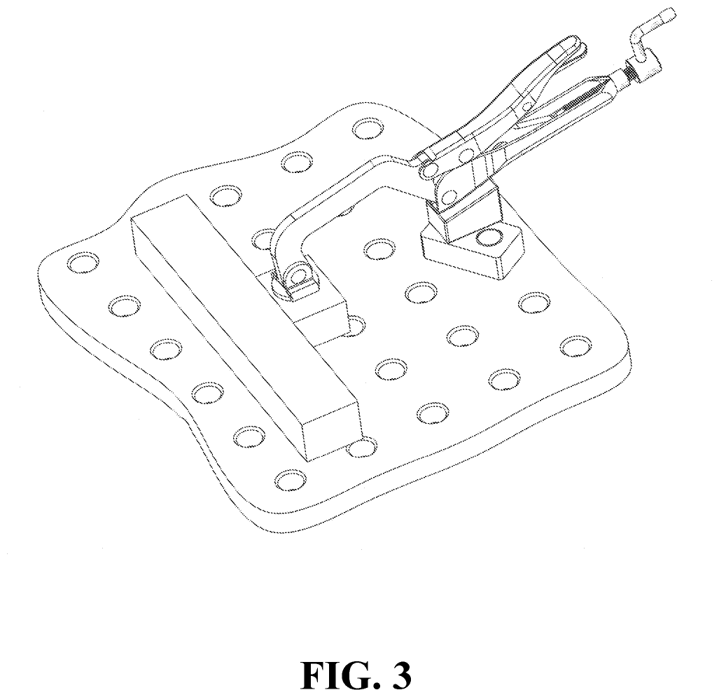

FIG. 3 shows a clamp being set up to clamp a small workpiece next to a large workpiece with the present invention mounted between the base of the clamp and a hole on a welding table. The base of the clamp has a threaded hole matching the dimensions of the threaded portion of the hex-head screw. As shown, the clamp is free to rotate on the present invention even after tightening the hex-head screw to the base of the clamp.

1. A position shifting base, comprising:
a substantially rectangular block,
a cylindrical stud extending from a bottom side of said block,
a cylindrical hole made in the same axial direction as said cylindrical stud and through the body of said block, said cylindrical hole is divided into a upper portion and a lower portion, and
a hex-head screw sized to fit through said cylindrical hole wherein said hex-head screw is longer than the thickness of the body of said block and comprises a screw head portion, a middle portion and a threaded portion.

2. The position shifting base of claim 1, wherein the diameter of the screw head portion of said hex-head screw is larger than that of the middle portion, and the diameter of the middle portion is larger than that of the threaded portion, and wherein the diameter of the cylindrical hole's upper portion is sized to fit the middle portion of the hex-head screw, and the diameter of the cylindrical hole's lower portion is sized to fit the screw head portion of the hex-head screw.

3. The position shifting base of claim 2, wherein the center line of the cylindrical stud and the centerline of the cylindrical hole are one inch apart.
